(19) United States
(12) Patent Application Publication
(10) Pub. No.: US 2008/0006707 A1
(43) Pub. Date: Jan. 10, 2008

(54) SHOWERHEAD WITH SIMPLIFIED ACTUATOR

(76) Inventor: Fabrizio Nobili, San Vittore (CH)

Correspondence Address: SEED INTELLECTUAL PROPERTY LAW GROUP PLLC, 701 FIFTH AVE, SUITE 5400, SEATTLE, WA, 98104, US

(21) Appl. No.: 11/459,215

(22) Filed: Jul. 21, 2006

(30) Foreign Application Priority Data
Jul. 6, 2006 (EP) 06014030.8

(51) Int. Cl. G05D 23/13

(52) U.S. Cl. 236/12.12

(57) ABSTRACT

The present invention relates to a showerhead of a type which is connected by a flexible conduit to a mixer tap assembly controlling the delivery of fluid, the showerhead including at least one electric control connected to a power drive means for controlling the fluid outflow, said power drive means being associated with the mixer tap assembly. Advantageously, the electric control comprises an on/off control pushbutton for the fluid outflow. Also provided is at least a second electric control for controlling the fluid temperature.

### BACKGROUND OF THE INVENTION

1. Field of the Invention

The present invention relates to a showerhead with simplified actuator.

More particularly, the invention relates to a showerhead of a type which is connected by a flexible conduit to a mixer tap assembly controlling the delivery of fluid.

The invention relates, particularly but not solely, to a showerhead for use as a dispenser of fluid placed at the free end of a flexible conduit on a kitchen sink, and the following description will cover that specific field of application for convenience of illustration only.

2. Description of the Related Art

As the skilled person in the art is well aware, there are currently available on the market a number of showerheads for sink installation, which vary from one another by their design, size, and mode of operation.

Such showerheads are piped, as by means of a flexible conduit, to a mixer tap assembly controlling the fluid outflow, i.e. operative to throttle the issuing jet of cold, warm, or mixed water. The mixer tap assembly is usually wall-mounted beneath the sink, although it may be found to jut out from the wall above the sink in some instances.

A user can grasp the showerhead with a hand and pull it out, from a holding fixture through which the flexible conduit used for piping the showerhead to the mixer tap assembly would then be slipped back to an out-of-sight storage position. These showerheads are also called pull-out spouts in the art.

The showerhead holding fixture is provided at a tap end overhanging the sink, and forms the dispensing end of the tap.

It should be noted that the tap may be a single-control mixer tap having a manually operated control handle, mounted a top or to one side, for discharging or shutting off a water outflow as well as adjusting the cold/warm water mixing.

However, the showerhead is more frequently provided with a manual control in the form of a mechanical pushbutton, whereby the water outflow can be switched between an undivided stream issuing through a central orifice and a spread shower pattern through a plurality of tiny peripheral orifices around the central one.

There are different ways of so switching the outflow from the showerhead, one of which is disclosed in European Patent Application No. 1 577 016 by this Applicant, for instance.

While being advantageous on several counts and substantially achieving their objectives, the above-mentioned prior designs have a limitation in that a user is to first actuate the control handle of the tap mounted fixedly at the sink before he/she can have water delivered through the showerhead, and is then to switch to a different delivery mode by actuating the control at the showerhead.

The underlying technical problem of this invention is to provide a showerhead with such constructional and functional features as are effective to make its operation simpler by essentially disposing of the control handle for the showerhead-terminated tap, as well as to overcome the limitations on prior art designs.

Another object of this invention is to provide a showerhead, which incorporates all the control members required for both actuating it and adjusting the outflow rate.

### BRIEF SUMMARY OF THE INVENTION

The solution idea on which the present invention stands is that of having at least one electric control incorporated in the showerhead, which control is coupled electrically to a power drive means associated with the mixer tap assembly for shutting off and/or adjusting the fluid outflow.

In this manner, the control handle for the single-control mixer tap holding the showerhead and its flexible conduit becomes substantially unnecessary, such that the tap can serve essentially a mere supporting function for the showerhead pull-out fixture, and may even be removed altogether where the sink, or a sink-enclosing cabinet, comes equipped with a fixture of its own for storing the showerhead and its flexible conduit out of sight.

It should be mentioned that in a preferred embodiment, the showerhead is provided with at least a pair of electric controls, one for discharging and shutting off the fluid outflow, and another for adjusting the temperature of the issuing flow by mixing streams of cold and warm water in various proportions together.

A first embodiment of the invention relates to a showerhead connected by a flexible conduit to a mixer tap assembly controlling the delivery of a fluid, and including at least one electric control connected to a power drive means for controlling the fluid outflow, said power drive means being associated with the mixer tap assembly.

Another embodiment of the invention relates to a fluid delivery control assembly, including a simplified actuation pull-out showerhead piped to the assembly by a flexible conduit, characterized in that it comprises a fluid control power drive means being associated with the mixer tap assembly and driving respective valves provided between said flexible conduit and a cold and/or warm fluid supply outlet; at least one electric control incorporated in said showerhead; and an electronic control unit connected to said electric control and power driven means.

The features and advantages of the showerhead and the mixer assembly according to the invention can be more clearly understood by having reference to the following description of an embodiment thereof, given herein by way of example and not of limitation, and to the accompanying drawings.

### BRIEF DESCRIPTION OF THE SEVERAL VIEWS OF THE DRAWING(S)

FIG. 1 shows schematically a mixer tap assembly for controlled delivery of fluid. According to one embodiment of the invention and is connected to a water system supply of cold/warm water.

FIG. 2 shows schematically the control assembly of FIG. 1 complete with electrical connections.

FIG. 3 is a top plan view showing schematically the control assembly of FIG. 1 isolated, with its water and/or electrical connections left out.

FIG. 4 is a bottom plan view showing schematically the control assembly of FIG. 3.

FIG. 5 is a side view showing schematically the control assembly of FIG. 3.

FIG. 6 is a cross-sectional view in section showing schematically the control assembly of FIG. 3, viewed along Section 6-6.

FIG. 7 is a block diagram of an electronic unit associated with the control assembly of an embodiment of this invention.

FIG. 8 shows schematically a modified embodiment of the fluid delivery control assembly according to this invention, in a configuration where it is connected to a cold/warm water supply.

FIG. 9 shows schematically the control assembly of FIG. 8 complete with electrical connections.

FIGS. 10, 10A and 11 are front, side and sectional views, respectively, showing schematically a detail of the control assembly of FIG. 8.

FIG. 12 is a top plan view showing schematically the control assembly of FIG. 8 isolated, with its water and/or electrical connections omitted.

FIG. 13 is a bottom plan view showing schematically the control assembly of FIG. 12.

FIG. 14 is a side view showing schematically the control assembly of FIG. 12.

FIG. 15 is a partial side view showing schematically in section the control assembly of FIG. 12, viewed along Section 15-15.

FIG. 16 is a perspective view showing schematically the control assembly of FIG. 13.

FIG. 17 is a block diagram of an electronic unit associated with the control assembly in the modified embodiment shown in FIG. 8.

FIG. 18 is a block diagram of an electronic unit that may be associated with the control assembly in either the embodiment shown in FIG. 1 or the modification shown in FIG. 8.

FIG. 19 is a perspective view of a showerhead associated with the control assembly according to the invention.

### DETAILED DESCRIPTION OF THE INVENTION

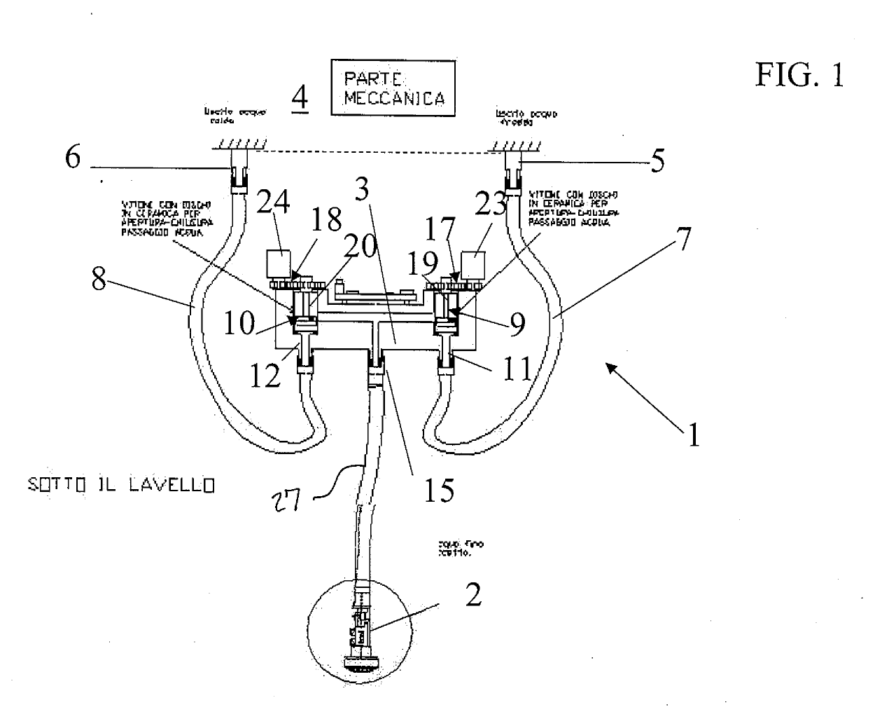

With reference to the drawing figures, specifically to the example in FIG. 1, generally and schematically shown at 1 is a fluid delivery control assembly according to an embodiment of this invention, the control assembly 1 comprising a showerhead 2 with a simplified actuation arrangement to be described.

The illustrated control assembly 1, also referred to as the mixer assembly, comprises a unitary body 3 mounted to a wall 4 proximate to water supply outlets 5 and 6 for cold and warm water, respectively.

The unitary body 3 may be mounted beneath a sink of conventional design, not shown, which would usually be installed level with or above said outlets 5, 6.

It should be understood that the unitary body 3 could be located elsewhere, for instance above the sink, or be recessed in the wall 4, optionally behind a door.

Likewise, the fluid delivery control assembly 1 according to this invention could be installed in a bathroom, beneath a washbasin or close by a bathtub.

The unitary body 3 has respective fluid inlets 11, 12 connected to outlets 5, 6 of a cold/warm water supply by flexible conduits 7 and 8, respectively.

The inlets 11, 12 are in fluid communication with a delivery outlet 15 formed in the unitary body 3 at an intermediate position equidistantly from said inlets 11, 12.

Advantageously in this invention, respective valves 9, 10 are provided in the fluid path from each fluid inlet 11 and 12 to the delivery outlet 15. The valves 9, 10 are fluid shut-off valves that also function to adjust the outflow rate according to the extent of an angular shift impressed on their stems.

More particularly, a first valve 9 is mounted in a respective seat formed in the body 3 aside the cold water outlet 5, and the second valve 10 is mounted in a respective seat formed in the body 3 aside the warm water outlet 6.

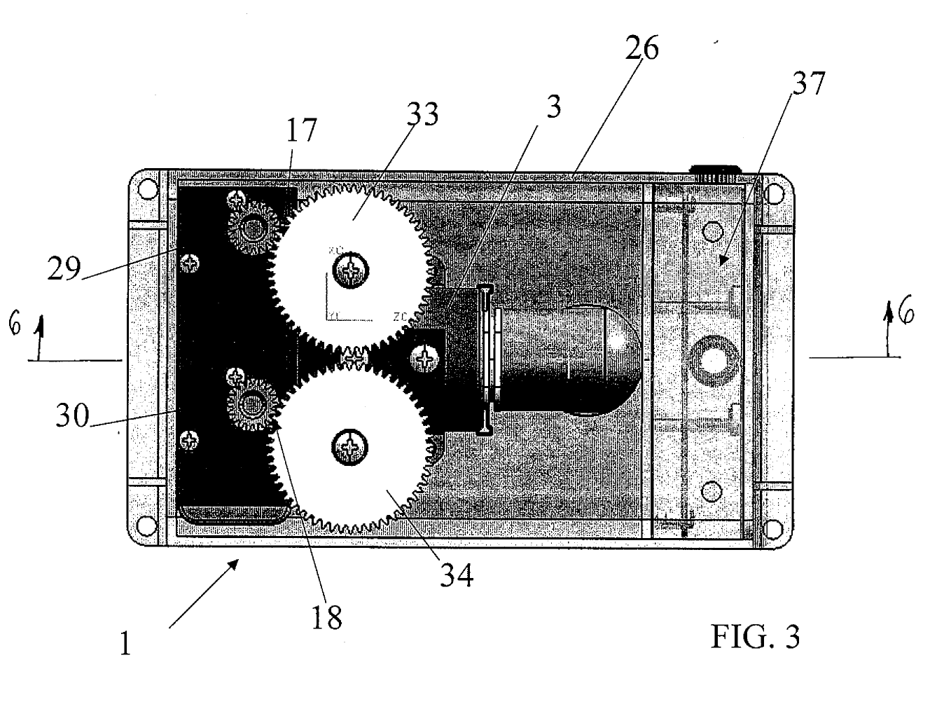

The valves 9, 10 are continual-action valves, and provided with respective actuating stems 19, 20 which extend from the valve seats and are made rigid with respective gears 29, 30 (FIG. 3), for rotation therewith.

An electro-mechanic assembly is provided in the unitary block 3 for driving and mixing the fluid flow toward the showerhead. For instance a power drive means is provided for electrically operating the valves 9, 10. This power drive means comprises electric motors 23, 24 whose output shafts are rigidly coupled each to a respective one of the gears 33, 34 (FIG. 3) in mesh engagement with the gears 29, 30 of the valves 9, 10, respectively.

Each motor may be a DC gear motor connected to a power output of an electronic control unit to be described.

Specifically, the motor 23 rotates the drive gear 29 meshing with the gear 33 attached to the stem of the valve 9.

The motor 24 likewise rotates the drive gear 30 in mesh engagement with the gear 34 attached to the stem of the valve 10. The gears 30 and 34 are a predetermined drive step-down ratio enabling each gear motor to drive a corresponding valve to open in a fine continual movement.

Thus, each motor 23, 24 will control its respective valve 9, 10 to open, and hence the outflow rates of cold and warm water, respectively.

Advantageously in this invention, the fluid delivery control assembly 1 includes a showerhead 2 which is piped to the outlet 15 of the body 3 by a flexible conduit 27, and includes at least one electric control or command 28 that is electrically coupled to the motor means 23, 24 driving the valves 9, 10 in the control assembly 1.

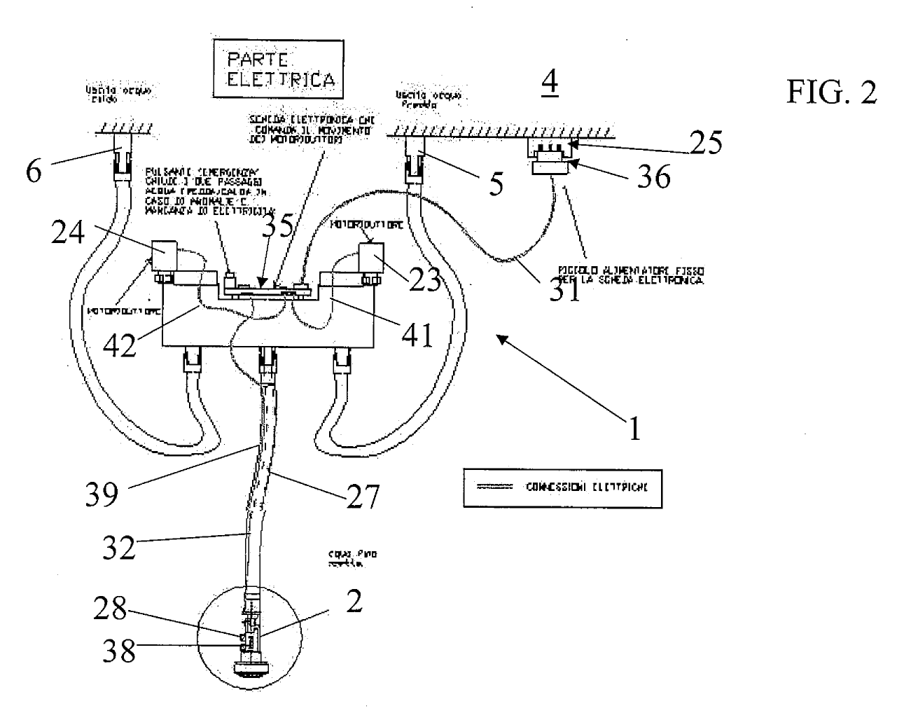

As shown in FIG. 2, the electric control 28 in the illustrated embodiment is preferably a pushbutton for controlling the fluid outflow on/off.

The electric signal generated by operating the control 28 is processed through the electronic unit 35, to be described in detail below, associated with the control assembly 1.

By providing the pushbutton 28 with a continual action feature, the fluid outflow rate can be controlled.

At least a second electric control or command 38 is mounted on the illustrated showerhead 2 for controlling the fluid temperature.

In a preferred embodiment, the first 28 and second 38 electric controls or commands are connected to the electronic unit 35 through an electric line 39 running along the flexible conduit 27 inside a protective sheath 32 of the flexible conduit.

FIG. 2 shows schematically the layout of the electric connections established between the electronic unit 35 and components of the fluid delivery control assembly 1.

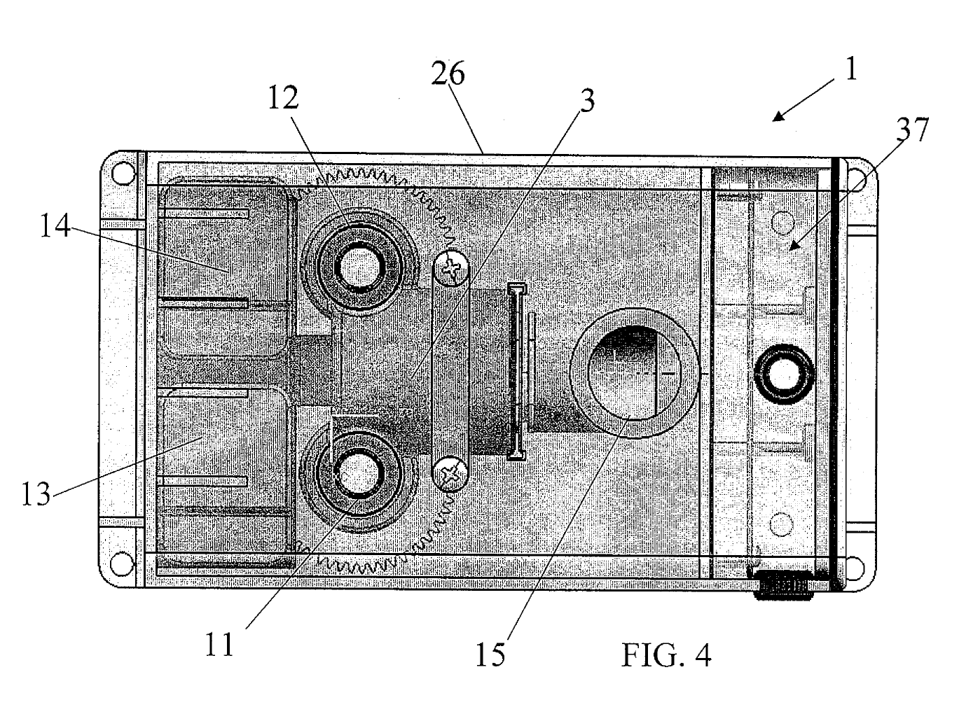

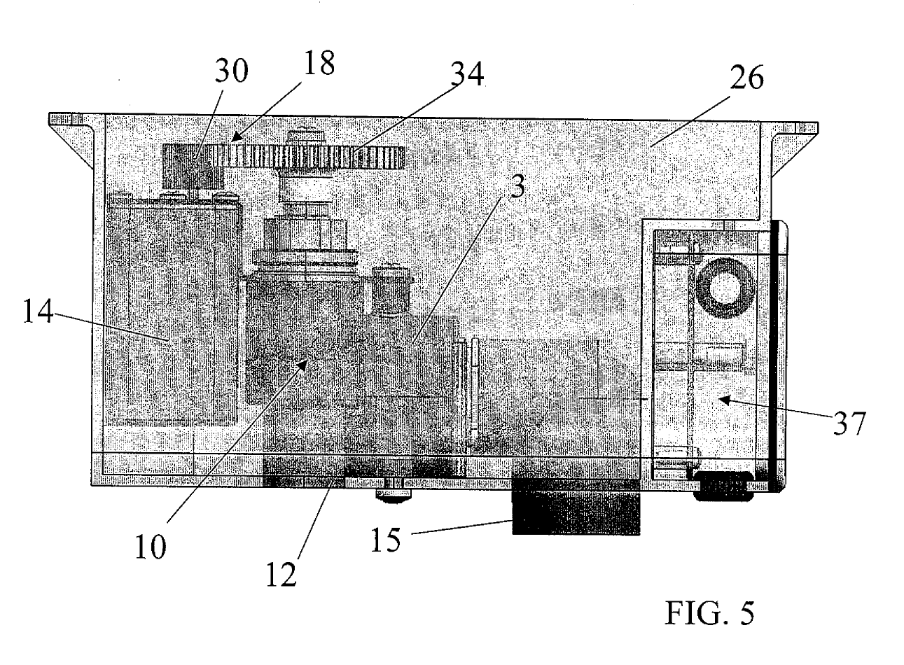

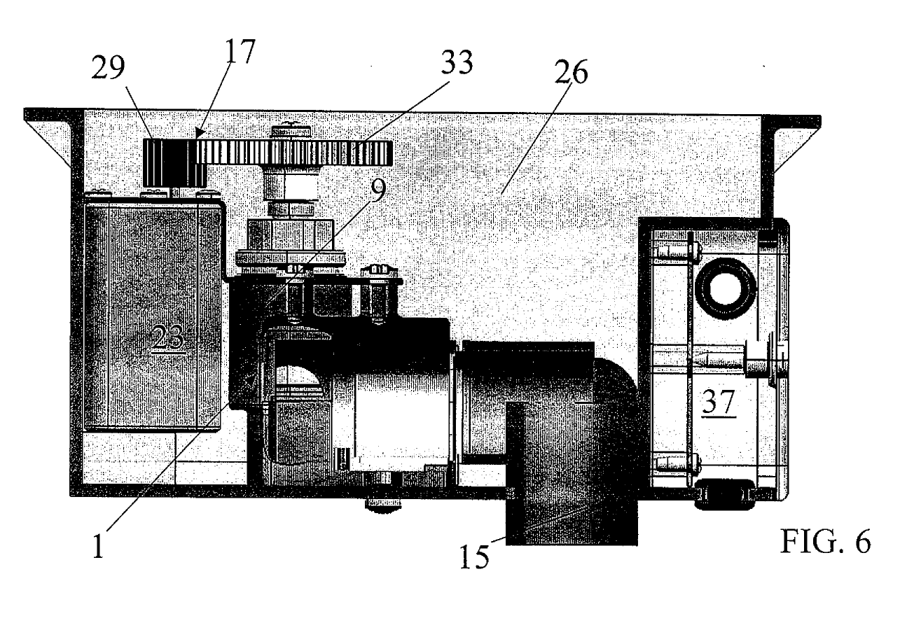

Advantageously, the electronic unit 35 is mounted within a sealed portion 37 of a protective enclosure 26 of the control assembly 1, as shown in FIGS. 3 to 6.

The illustrated enclosure 26 is formed from a clear synthetic plastics material for convenient service inspection of the components of the mixer assembly 1. To one side of the enclosure 26 is the portion 37 housing the electronic unit 35 which is supplied a mains voltage via an external transformer 36 plugged in a wall-mounted socket 25 provided close by the water supply outlets 5, 6, as shown in FIG. 2.

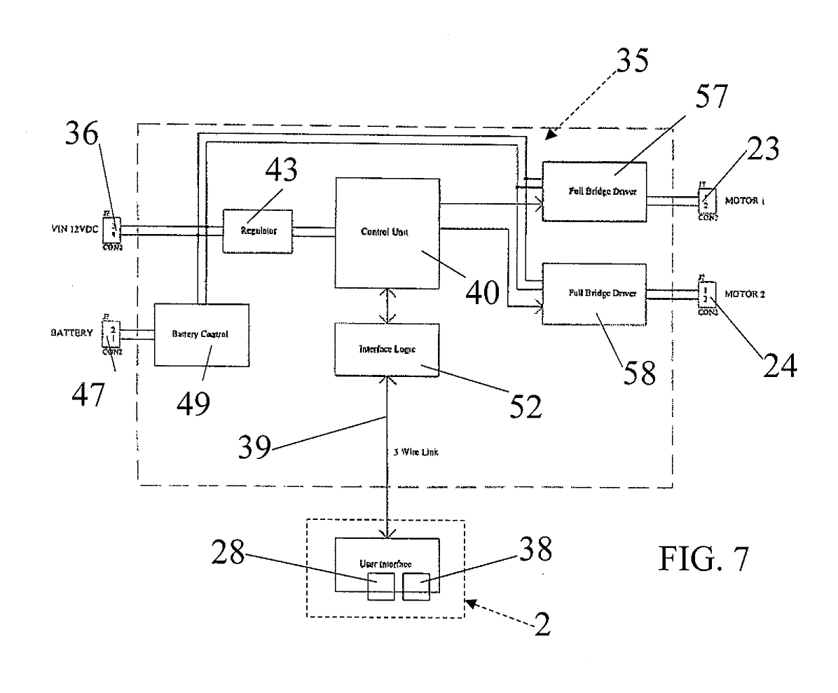

Respective electric connections 41,42 are established between the unit 35 and each motor 23, 24, as well as between the electronic unit 35 and each pushbutton 28, 38 on the showerhead 2. The last-mentioned connections are shown schematically in FIGS. 2 and 7 as a single three-wire cable 39.

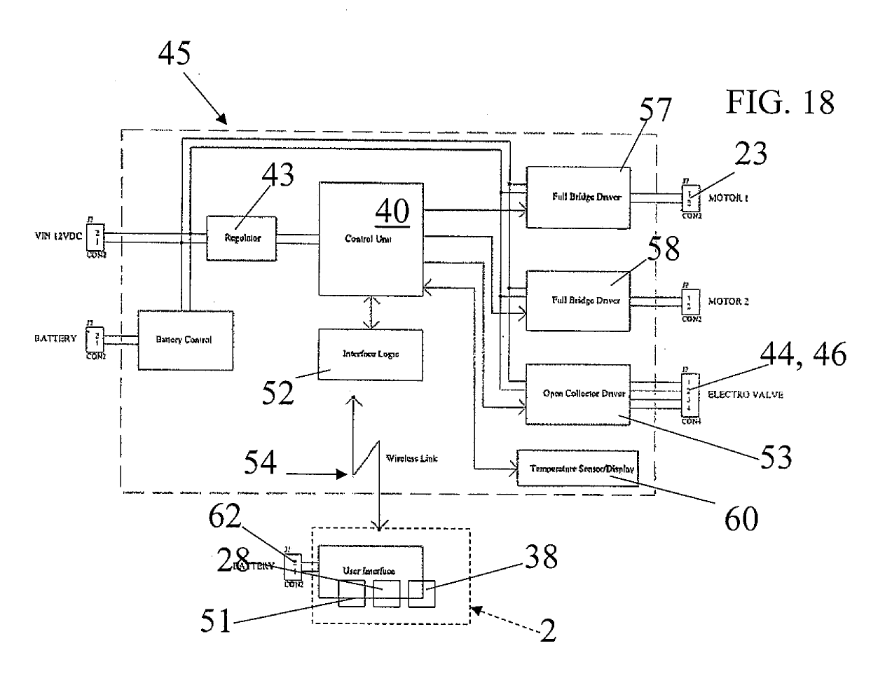

It is worth mentioning that the cable 39 is not strictly necessary to the invention, since the pushbuttons 28, 38 may be coupled electrically to the electronic unit 35 by a wireless link. For this purpose, the showerhead may be provided with an RF signal transmitting device, and the unit 35 may incorporate a suitable receiver for such RF signals. This option is shown schematically in FIG. 18 and discussed below.

With reference to the diagram of FIG. 7, the electronic unit 35 comprises a control unit 40 powered through the external transformer 36 via a voltage regulator 43. The electronic unit 35 is carried on a card contained in the portion 37 of the enclosure 26.

A replaceable battery 47 is provided externally to also keep the electronic unit 35 operative on the occurrence of a main power shortage. A circuit portion 49 on the card of the unit 35 is arranged to regulate the power supply from the battery 47.

The control unit 40 may be an IC microcontroller having a plurality of control outputs for enabling respective output stages 57, 58 of the power transistor bridge or half-bridge type arranged to control the motors 23, 24 of the valves 9, 10.

Furthermore, an interface 52 is connected bi-directionally to the control unit 40 and the controls 28, 38 of the showerhead 2 by the cable 39.

Should the above description fall short of being exhaustive, it will be mentioned that the showerhead 2 can still be conventional as to its suitability for switching the water outflow between a solid stream mode through a central orifice and a spread stream mode through a plurality of tiny peripheral orifices around the central orifice.

This manual switching of the fluid outflow in no way affects the electric control arrangement described above and allowing the water outflow to be controlled on/off and adjusted for temperature and rate.

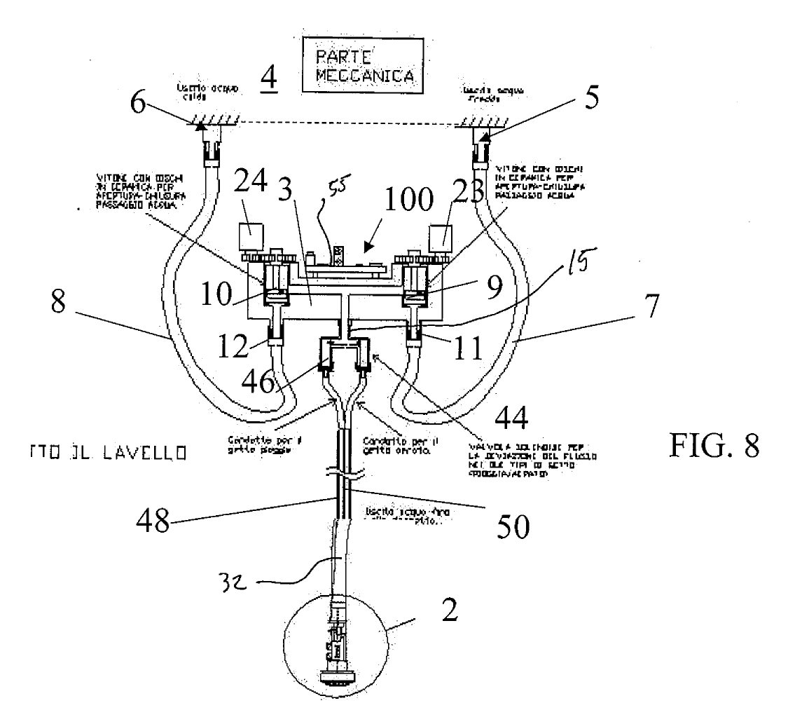

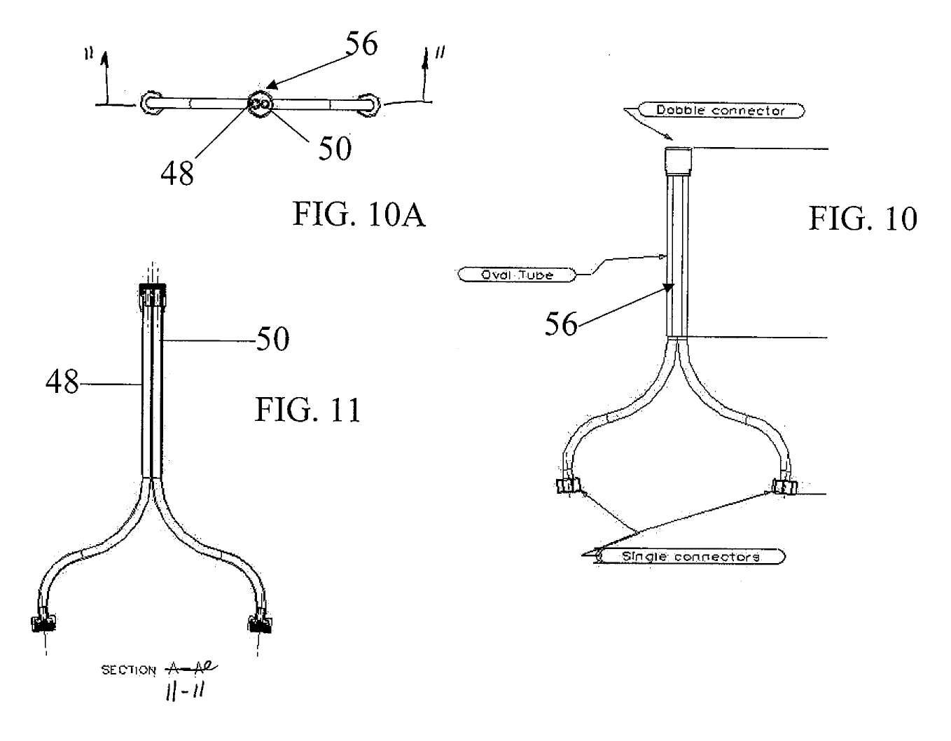

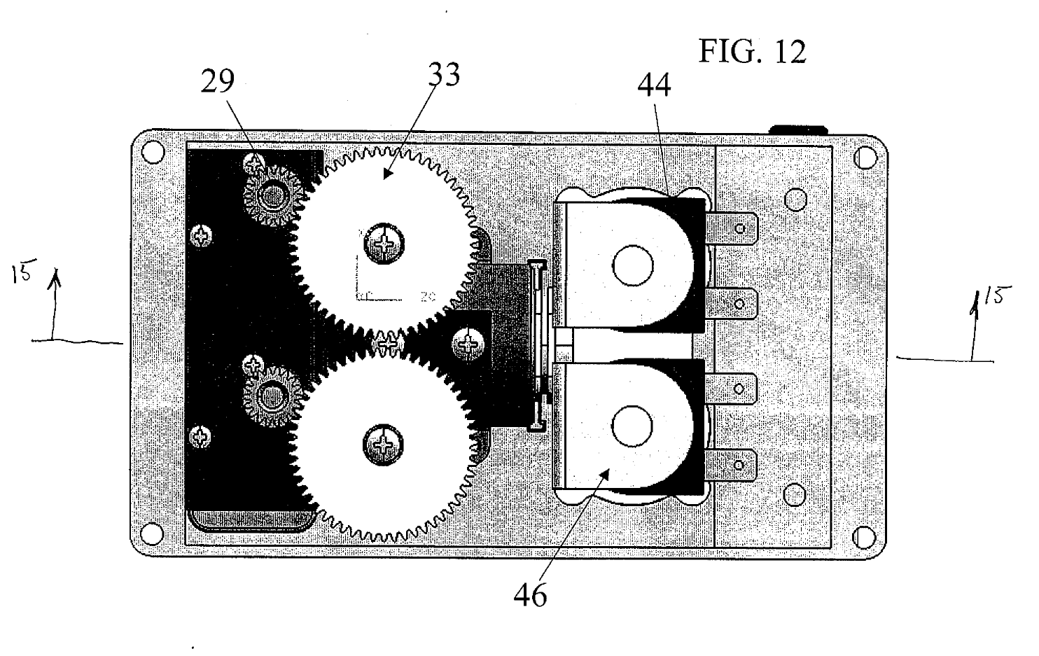

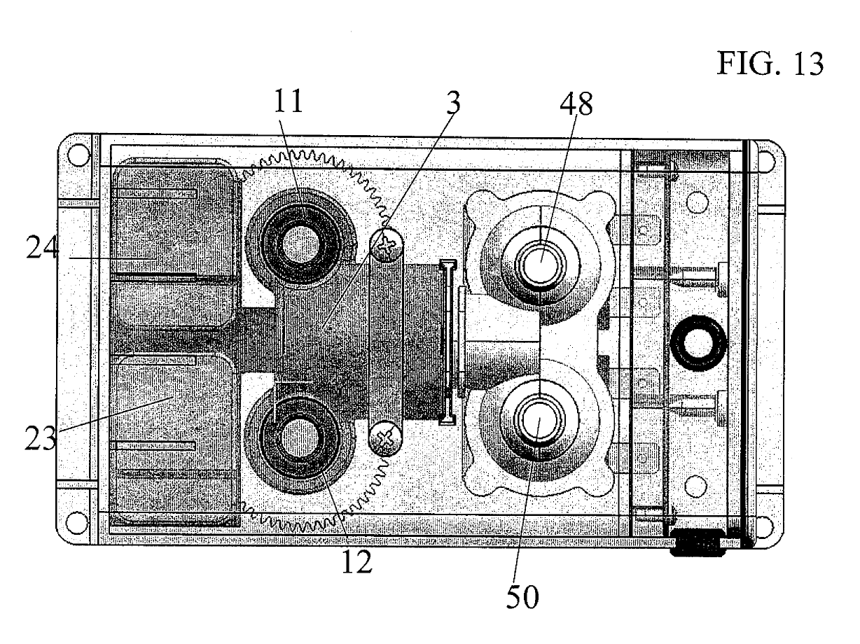

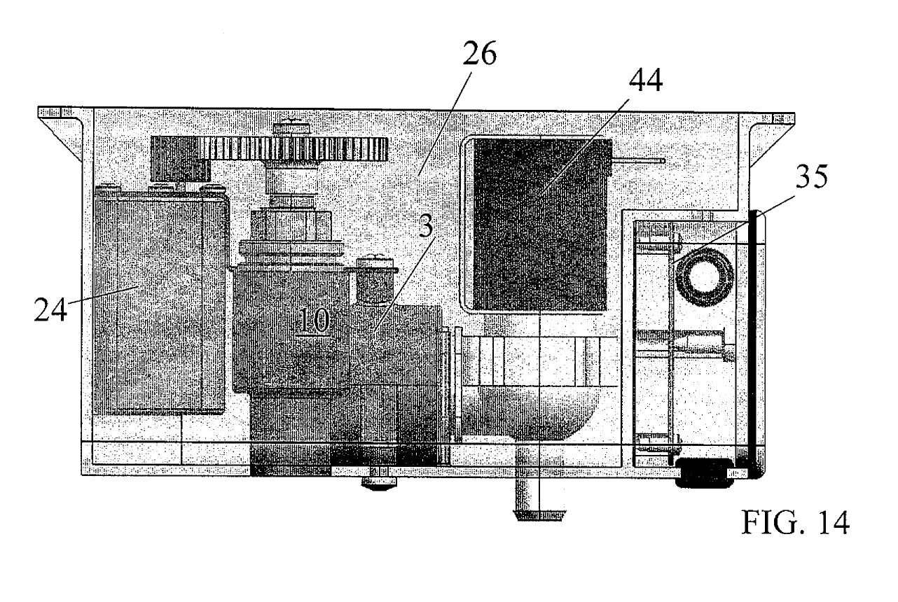

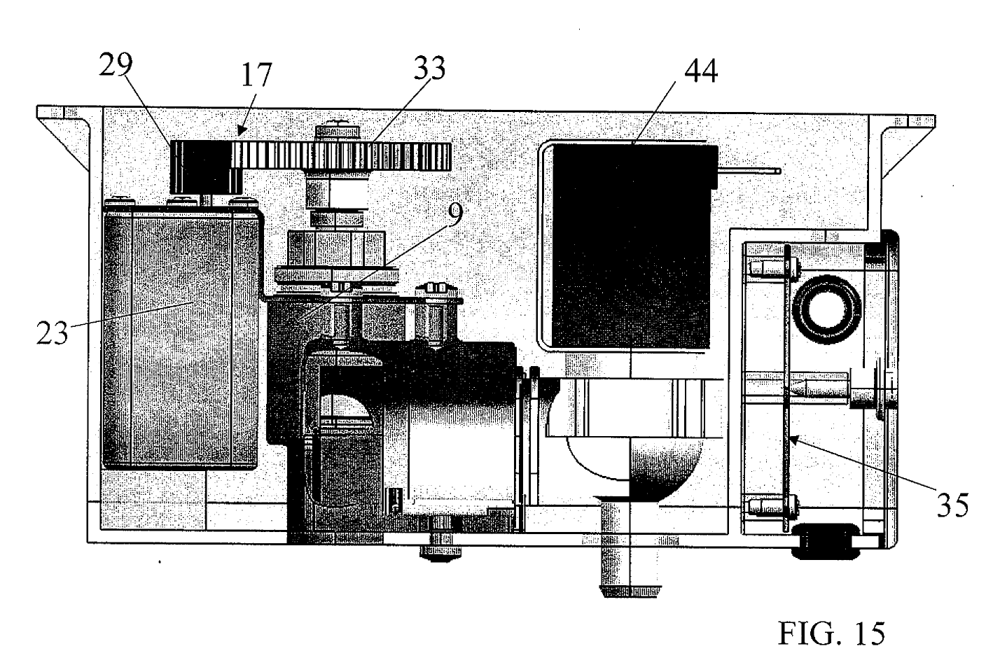

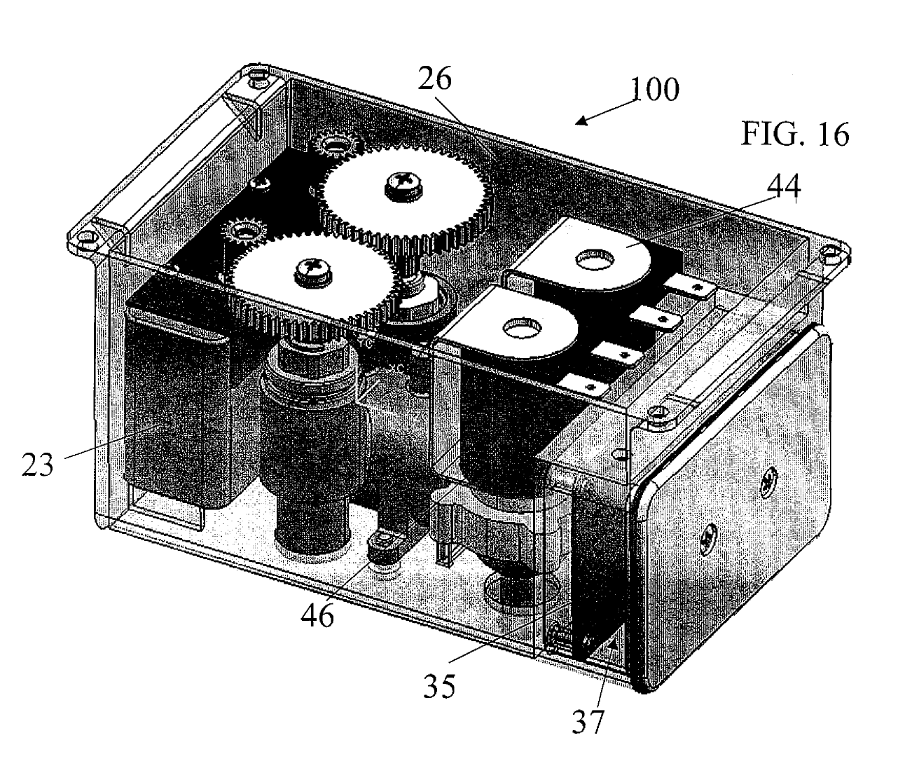

In a modified embodiment shown schematically in FIGS. 8 to 16, a fluid delivery control assembly according to this particular embodiment of the invention, denoted 100, has an additional feature in that the water outflow can be switched between the central and spread stream modes using an electric type of control.

In this modification, cooperating parts having the same construction and function as in the previously described embodiment carry the same reference numerals.

As explained below, this electric form of outflow switching is implemented by a novel design providing enhanced functionality for the control assembly 100, rather than being a mere adaptation of a conventional mechanical control.

For the purpose, two shut-off solenoid valves 44, 46 are incorporated in the control assembly 100 directly downstream of the delivery outlet 15.

Each solenoid valve 44, 46 is placed upstream of a respective flexible conduit 48, 50 conveying the fluid to the showerhead 2.

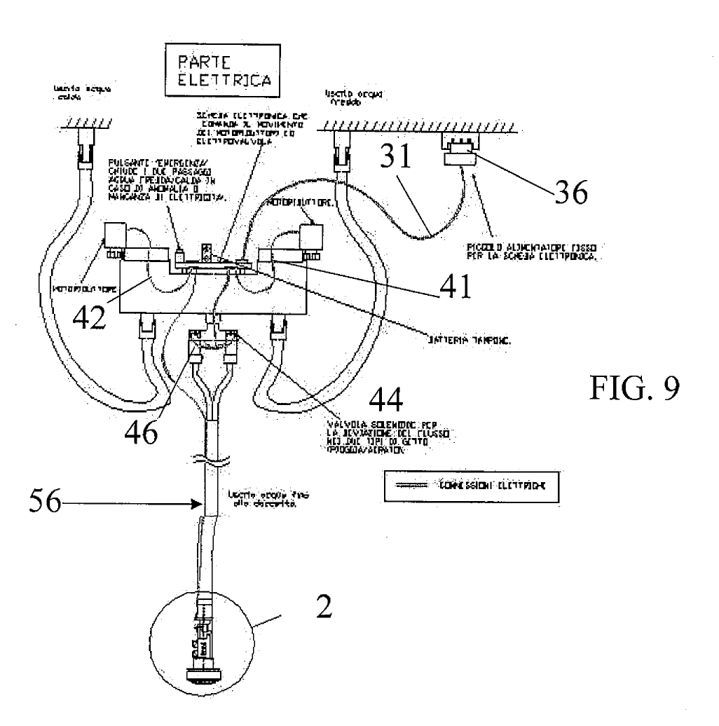

In particular, the two flexible conduits 48, 50 are paired longitudinally parallel to each other into a single, flexible water piping 56 (FIG. 9) to the showerhead 2.

More particularly, the flexible conduit 48 is in fluid communication with the central solid stream outflow orifice, while the other flexible conduit 50 is in fluid communication with the plurality of tiny orifices surrounding the central orifice in the showerhead 2.

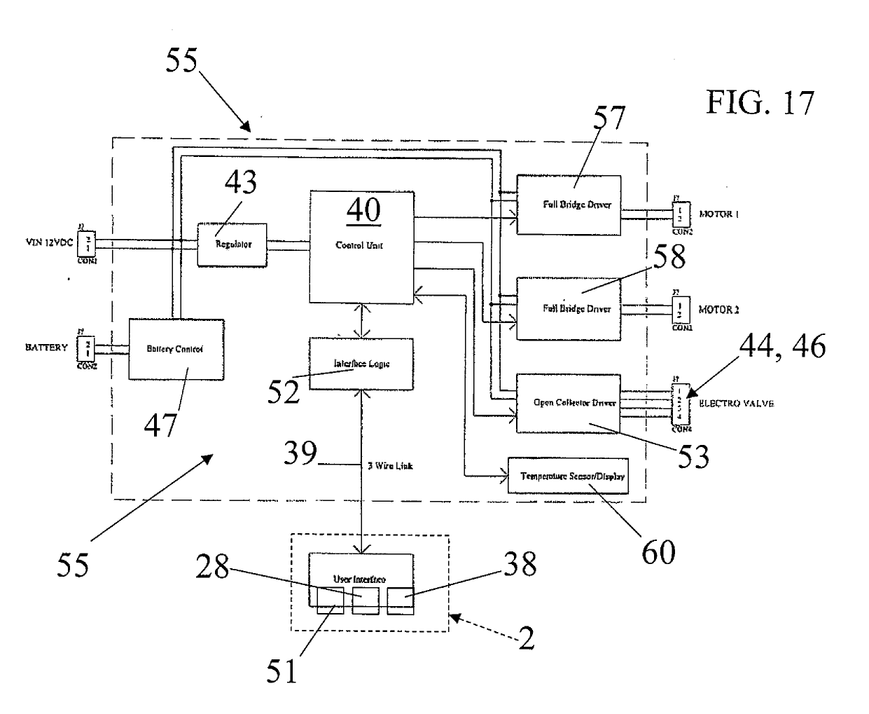

In this modification, moreover, the electric line that runs under the protective sheath 32 along the flexible water conduit is led to a corresponding electrically operated outflow switching command or pushbutton 51 (FIG. 17) on the showerhead 2. In addition, the two shut-off solenoid valves 44, 46 are individually connected electrically to an electronic unit 55, as shown in FIG. 17. This electronic unit 55 is an equivalent of the previously described unit 35 but for the inclusion of a circuit portion 53 special to control the solenoid valves 44, 46.

For this purpose, the electronic unit 55 comprises an additional output stage circuit portion 53, e.g. of the open collector type, which is connected to respective control outputs of the control unit 40 and drives each solenoid valve 44, 46.

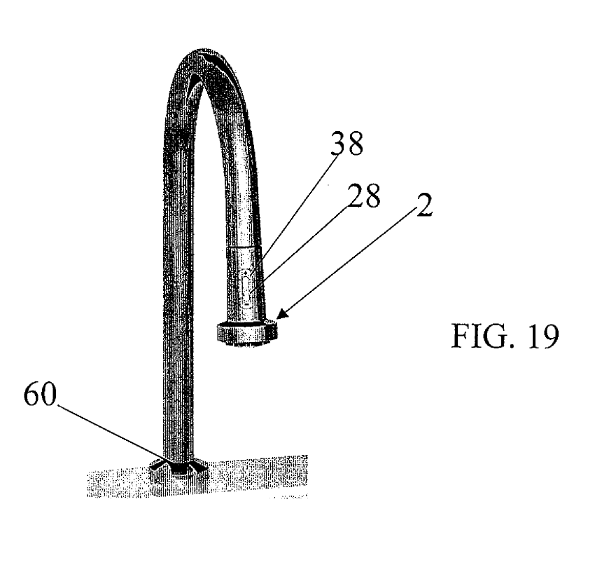

Both electronic units, namely the units denoted 55 in FIGS. 17 and 45 in FIG. 18, have a connection to a temperature sensor which may be placed proximate either to the outlet 15 of the body 3 or to the solenoid valves 44, 46, for example. This temperature sensor is associated with a display 60, shown in FIG. 19, allowing a user to also read the temperature of the water outflow.

By just depressing the pushbutton 51 located on the showerhead 2, the user can switch between delivery through the central orifice or the peripheral ones by closing either one of the solenoid valves, 44 or 46, for example the valve associated with the conduit that is not to receive water from the outlet 15 of the body 3. In other words, by depressing the pushbutton 51, the two solenoid valves 44, 46 can be controlled to open or close such that one of them will close while the other is open.

FIG. 18 shows an alternative arrangement of the electronic unit, generally denoted 45, which may also apply to the previously described embodiment of the invention.

This alternative embodiment of the electronic unit provides a wireless link between the controls on the showerhead 2 and the interface 52 to the control unit 40. The showerhead 2 is provided here with an RF signal transmitter, and the interface 52 includes a receiver for such RF signals. Additionally, a battery supply 62 is provided to the signal transmitter in the showerhead 2.

The above RF wireless link is generally shown at 54 in FIG. 18.

It can be appreciated from the foregoing that the mixer assembly of this invention does solve the previously mentioned technical problem, and offers a number of advantages, foremost among which is the fact that the fluid outflow can be dispensed, at controlled temperature and rate, by just manipulating the pushbuttons on the showerhead 2.

The showerhead response to such a user's action is immediate, since the showerhead would be grasped in the user's hand anyhow, whenever there is a demand for water to be dispensed through it.

The invention eliminates the need of a mechanical control handle on the faucet holding the pull-out showerhead.

Also, controlling the water outflow is a simple and effective operation, wherein the only manual action in order to have the fluid dispensed essentially narrows down to grasping the showerhead with one hand.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A showerhead of a type connected by a flexible conduit to a mixer tap assembly controlling the delivery of a fluid, and including at least one electric control connected to a power drive means for controlling the fluid outflow, said power drive means being associated with the mixer tap assembly.

2. A showerhead according to claim 1, wherein said electric control comprises an on/off control pushbutton for the fluid outflow.

3. A showerhead according to claim 1, including at least a second electric control for adjusting the fluid temperature.

4. A showerhead according to claim 2, wherein said pushbutton is a continual action pushbutton for controlling the fluid outflow rate.

5. A showerhead according to claim 1, wherein said power drive means comprises an electric motor associated with a respective fluid shut-off valve element mounted to said mixer tap assembly between said flexible conduit and a cold and/or warm fluid supply outlet.

6. A showerhead according to claim 1, wherein said electric motor is a DC gear motor.

7. A showerhead according to claim 1, including an electronic control unit having electric connections led thereto to serve said electric control and said power drive means.

8. A showerhead according to claim 7, wherein said electronic unit comprises a control unit having an input side connected to said at least one electric control and an output side connected to said power drive means via respective power stages.

9. A showerhead according to claim 7, wherein said electric control is connected to said electronic unit by a wireless link.

10. A showerhead according to claim 1, including an additional electric control of the pushbutton variety for switching the fluid outflow through the showerhead.

11. A fluid delivery control assembly, including a simplified actuation pull-out showerhead piped to the assembly by a flexible conduit, and comprising a fluid control power drive means being associated with the mixer tap assembly and driving respective valves provided between said flexible conduit and a cold and/or warm fluid supply outlet; at least one electric control incorporated in said showerhead; and an electronic control unit connected to said electric control and power driven means.

12. A fluid delivery control assembly according to claim 11, wherein said electric control comprises an on/off control pushbutton for the fluid outflow.

13. A fluid delivery control assembly according to claim 11, further comprising at least a second electric control for adjusting the temperature of the outflowing fluid.

14. A fluid delivery control assembly according to claim 11, wherein said electric control is connected to said electronic unit by a wireless link.

15. A fluid delivery control assembly according to claim 11, wherein said electronic unit comprises a control unit having an input side connected to said at least one electric control and an output side connected to said power drive means via respective power stages.

16. A fluid delivery control assembly according to claim 11, comprising a pair of solenoid valves placed downstream of said fluid supply outlet, and a pair of flexible conduits each associated with a respective one of the solenoid valves to divert the fluid outflow either to a central orifice or to a plurality of peripheral orifices in said showerhead.

17. A fluid delivery control assembly according to claim 16, wherein said solenoid valve pair are operated by means of an additional electric control being located at said showerhead and connected to said electronic unit.

18. A fluid delivery control assembly according to claim 16, wherein said additional electric control is connected to said electronic unit by a wireless link.

19. A fluid delivery control assembly according to claim 11, wherein a temperature sensor and display arrangement is associated with said electronic unit to enable a user to read the temperature of the outflowing fluid.

20. A showerhead connected by a flexible conduit to a mixer tap assembly controlling the delivery of a fluid and including:
at least one electric command; and
power drive means associated with the mixer tap assembly;
said at least one electric command being electrically coupled to said power drive means for controlling the fluid outflow.

21. A showerhead according to claim 20, wherein said electric command comprises an on/off control pushbutton for the fluid outflow.

22. A showerhead according to claim 20, comprising at least a second electric command for adjusting the fluid temperature.

23. A showerhead according to claim 21, wherein said pushbutton is a continual action pushbutton for controlling the fluid outflow rate.

24. A showerhead according to claim 20, wherein said power drive means comprises an electric motor associated with a respective fluid shut-off valve element mounted to said mixer tap assembly between said flexible conduit and a cold and/or warm fluid supply outlet.

25. A showerhead according to claim 20, wherein said electric motor is a DC gear motor.

26. A showerhead according to claim 20, including an electronic control unit having electric connections led thereto to serve said electric command and said power drive means.

27. A showerhead according to claim 26, wherein said electronic unit comprises a control unit having an input side connected to said at least one electric command and an output side connected to said power drive means via respective power stages.

28. A showerhead according to claim 26, wherein said electric command is connected to said electronic unit by a wireless link.

29. A showerhead according to claim 20, including an additional electric command of the pushbutton type for switching the fluid outflow through the showerhead.
